(19) United States
(12) Patent Application Publication
(10) Pub. No.: US 2024/0424839 A1
(43) Pub. Date: Dec. 26, 2024

(54) AD HOC TYRE PRESSURE CONTROL ASSEMBLY

(71) Applicant: James Harris, Scarborough (AU)

(72) Inventor: James Harris, Scarborough (AU)

(21) Appl. No.: 18/690,251

(22) PCT Filed: Sep. 13, 2022
(86) PCT No.: PCT/AU2022/051105

§ 371 Date: Mar. 7, 2024

(30) Foreign Application Priority Data
Sep. 15, 2021 (AU) 2021902970

(51) Int. Cl. B60C 23/00

(52) U.S. Cl. CPC B60C 23/00345; B60C 23/00363

(57) ABSTRACT

Provided is an ad hoc tyre pressure control assembly (10) for a tyred vehicle. Specifically. the assembly (10) includes a pressure transfer arrangement (18) comprising a stator annulus (20) configured to be mounted about an axle (6) of a vehicle and arrangeable in fluid communication with a charging valve (16). the stator annulus (20) defining a first peripheral sealing surface (24). Arrangement (18) also includes a rotor annulus (22) configured to be mounted to a tyred wheel (8) of said vehicle and arranged in fluid communication with such a tyre (8.2) via a controllable check valve (30). the rotor annulus (22) defining a second peripheral sealing surface (26). and an urging component (36) configured to provide a predetermined urging force between the annuli (20) and (22) to separate the first and second peripheral sealing surfaces (24) and (26). One annulus defines an internal (38) raceway in which the other annulus is complementarily captured to allow substantially unimpeded relative co-axial rotation between said annuli, and the annuli are complementarily configured to define an airtight air transfer passage (28) between the charging and check valves when the predetermined urging force is overcome and the first and second peripheral sealing surfaces are brought into abutment, so that pressurised air is transferrable through said pressure transfer arrangement without impeding rotation of the wheel on said axle.

### TECHNICAL FIELD

This invention broadly relates to the on-demand inflation of tyres on vehicles, and more specifically to an ad hoc tyre pressure control assembly and such a tyred vehicle having such an ad hoc tyre pressure control assembly fitted thereto.

### BACKGROUND ART

The following discussion of the background art is intended to facilitate an understanding of the present invention only. The discussion is not an acknowledgement or admission that any of the material referred to is or was part of the common general knowledge as at the priority date of the application.

The concept of a central tyre inflation system (CTIS) for tyred vehicles is known. In general, a central tyre inflation system allows the operator of the vehicle to control the air pressure in the tyres. Controlling the air pressure in the tyres is especially advantageous for off-road vehicles. For example, an off-road vehicle may be required to operate on soft ground, sand or swamps. To obtain traction in such an environment, the tyre pressure is typically reduced to provide for larger tyre contact patches with the surface, thereby increasing traction.

Such an off-road vehicle may be also required to travel on harder surfaces, such as paved or sealed roads. To obtain proper traction on harder surfaces and to enable the vehicle to operate safely at high speeds, the tyre pressure should be substantially higher than soft-surface pressures.

The difference between preferred high tyre pressures (hard surfaces) and preferred low tyre pressures (soft terrain) may be quite large. For example, some off-road tyres recommend a maximum tyre pressure of 250 kPa for paved or sealed road conditions and 50 to 150 kPa for extremely soft conditions, such as sand.

A further reason for the maintenance of recommended tyre pressures is fuel economy. Underinflated or soft tyres on sealed roads generally have a negative impact on fuel efficiency or mileage. Therefore, a central tyre pressure control system that facilitates easy control of tyre pressure according to requirements will improve traction performance and enhance fuel efficiency.

As such, the Applicant has identified a need in the art of central tyre inflation systems, particularly for vehicles useable in both on and off-road applications, where on-demand variability and control of tyre pressures are desired, and as applicable to both original equipment and for retrofitting existing vehicles not originally so equipped with a suitable tyre pressure management system. The current invention was conceived with this goal in mind.

### SUMMARY OF THE INVENTION

The skilled addressee is to appreciate that reference herein to ‘air’ generally refers to atmospheric air, but other fluids, i.e. liquids and/or gasses, may be apposite. Additionally, reference herein to a tyred vehicle generally refers to any suitable vehicle making use of a tyre or tyres.

According to a first aspect of the invention there is provided a pressure transfer arrangement for an ad hoc tyre pressure control assembly, said pressure transfer arrangement comprising:
a stator annulus configured to be mounted about an axle of a vehicle and arrangeable in fluid communication with a charging valve, the stator annulus defining a first peripheral sealing surface;
a rotor annulus configured to be mounted to a tyred wheel of said vehicle and arranged in fluid communication with such a tyre via a controllable check valve, the rotor annulus defining a second peripheral sealing surface; and
an urging component configured to provide a predetermined urging force between the annuli to separate the first and second peripheral sealing surfaces;
wherein one annulus defines an internal raceway in which the other annulus is complementarily captured to allow substantially unimpeded relative co-axial rotation between said annuli; and
wherein the annuli are complementarily configured to define an airtight air transfer passage between the charging and check valves when the predetermined urging force is overcome and the first and second peripheral sealing surfaces are brought into abutment, so that pressurised air is transferrable through said pressure transfer arrangement;
wherein selective control of the charging and check valves facilitates ad hoc tyre inflation or deflation of the tyre without impeding rotation of the wheel on said axle.

In an embodiment, the annuli are configured such that injection of pressurised air via the charging valve overcomes the predetermined urging force to bring the first and second peripheral sealing surfaces into abutment to form the airtight air transfer passage.

In an embodiment, the pressure transfer arrangement comprises an actuator configured to overcome the predetermined urging force to bring the first and second peripheral sealing surfaces into abutment to form the airtight air transfer passage.

In an embodiment, the actuator comprises a mechanical and/or electromechanical actuator.

In an embodiment, the first and second peripheral sealing surfaces comprise opposite hard-facing surfaces, such as tungsten carbide or silicon carbide, to facilitate sealing between the annuli whilst allowing unimpeded rotation.

In an embodiment, the urging component comprises a biased bearing configured to position one annulus within the raceway of the other annulus, the bearing including a biasing element, such as a spring, providing the predetermined urging force.

In an embodiment, the urging component comprises a magnet configured to position one annulus within the raceway of the other annulus, the magnet including a biasing element, such as a spring, providing the predetermined urging force.

In an embodiment, the pressure transfer arrangement comprises a skirt or valvular seal between the annuli where air flow or pressure is directed onto itself to form a seal when the first and second peripheral sealing surfaces are brought into abutment.

In an embodiment, the pressure transfer arrangement comprises a contaminant protection seal to prevent the ingress of unwanted contaminants into the air transfer passage.

In an embodiment, the annuli are incorporated into a brake arrangement of the wheel.

In an embodiment, the stator annulus comprises a brake caliper backing plate.

In an embodiment, the rotor annulus comprises a disc brake rotor.

According to a second aspect of the invention there is provided an ad hoc tyre pressure control assembly for a tyred vehicle, said assembly comprising:
an air reservoir configured to store pressurised air;
an air compressor configured to operatively charge said reservoir with pressurised air;
a selectively controllable charging valve arranged in fluid communication with said air reservoir; and
a pressure transfer arrangement comprising:
   i) a stator annulus configured to be mounted about of said vehicle and arranged in fluid an axle communication with the charging valve, the stator annulus defining a first peripheral sealing surface;
   ii) a rotor annulus configured to be mounted to a tyred wheel of said vehicle and arranged in fluid communication with such a tyre via a controllable check valve, the rotor annulus defining a second peripheral sealing surface; and
   iii) an urging component configured to provide a predetermined urging force between the annuli to separate the first and second peripheral sealing surfaces;
wherein one annulus defines an internal raceway in which the other annulus is complementarily captured to allow substantially unimpeded relative co-axial rotation between said annuli; and
wherein the annuli are complementarily configured to define an airtight air transfer passage between the charging and check valves when the predetermined urging force is overcome and the first and second peripheral sealing surfaces are brought into abutment pressurised air is so that transferrable through said pressure transfer arrangement;

so that selective control of the charging and check valves facilitates ad hoc tyre inflation or deflation without impeding rotation of the wheel on said axle.

In an embodiment, the air reservoir and compressor are unitary, such as a pump and tank combination.

Typically, the air compressor is configured to be energised by means of a vehicle electrical system, such as a 12V system.

In an embodiment, the assembly comprises an air pressure sensor configured to sense and indicate pressure within the air reservoir and/or tyre.

In an embodiment, the charging valve comprises a solenoid valve for transferring compressed air from the air reservoir, via the pressure transfer arrangement, to the tyre.

Typically, the selectively controllable charging valve is controllable from a cabin of the vehicle.

In an embodiment, the controllable check valve is configured to allow one-way pressurised air from the pressure transfer arrangement into the tyre to inflate said tyre.

In an embodiment, the controllable check valve is controllable from a cabin of the vehicle to vent pressurised air to the atmosphere to deflate said tyre.

In an embodiment, the pressure transfer arrangement comprises the pressure transfer arrangement of the first aspect of the invention.

According to a third aspect of the invention there is provided a tyred vehicle comprising an ad hoc tyre pressure control assembly in accordance with the second aspect of the invention.

In an embodiment, the vehicle comprises an air pressure sensor configured to sense and indicate pressure within the air reservoir and/or tyre.

According to a fourth aspect of the invention there is provided a method of inflating a tyre of a vehicle, said method comprising the steps of:
providing a vehicle fitted with an ad hoc tyre pressure control assembly in accordance with the first aspect of the invention; and
controlling the charging valve of said assembly in order to transfer pressurised air from the air reservoir via the pressure transfer arrangement to the tyre.

In an embodiment, the method includes the step of deflating the tyre by controlling the check valve of the assembly to discharge pressurised air from the tyre to the atmosphere.

According to a further aspect of the invention there is provided a pressure transfer arrangement, an ad hoc tyre pressure control assembly and a tyred vehicle including such an ad hoc tyre pressure control assembly, substantially as herein described and/or illustrated.

### BRIEF DESCRIPTION OF THE DRAWINGS

The description will be made with reference to the accompanying drawings in which:

FIG. 1 is a diagrammatic front-sectional representation of an embodiment of an ad hoc tyre pressure control assembly, in accordance with aspects of the present invention;

FIG. 2 is a diagrammatic perspective-view representation of one embodiment of a pressure transfer arrangement of the ad hoc tyre pressure control assembly of FIG. 1;

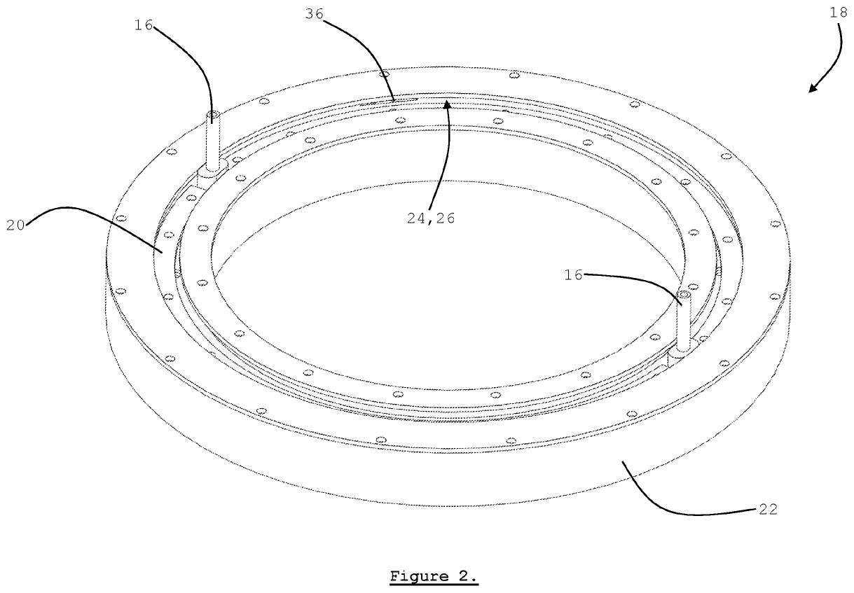

FIG. 3 is diagrammatic perspective-view representation of a further embodiment of a pressure transfer arrangement of the ad hoc tyre pressure control assembly of FIG. 1;

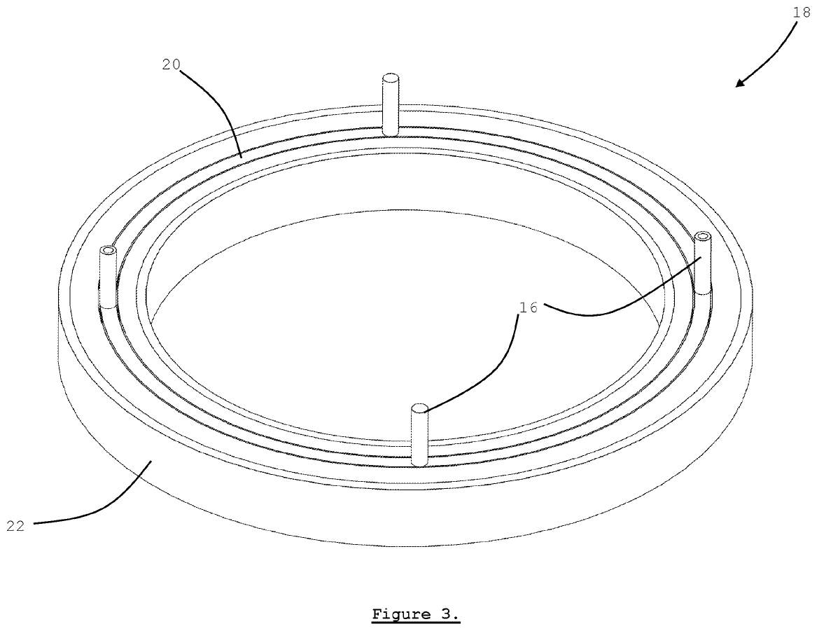

FIG. 4 is a diagrammatic top-view exploded representation of the pressure transfer arrangement of FIG. 2;

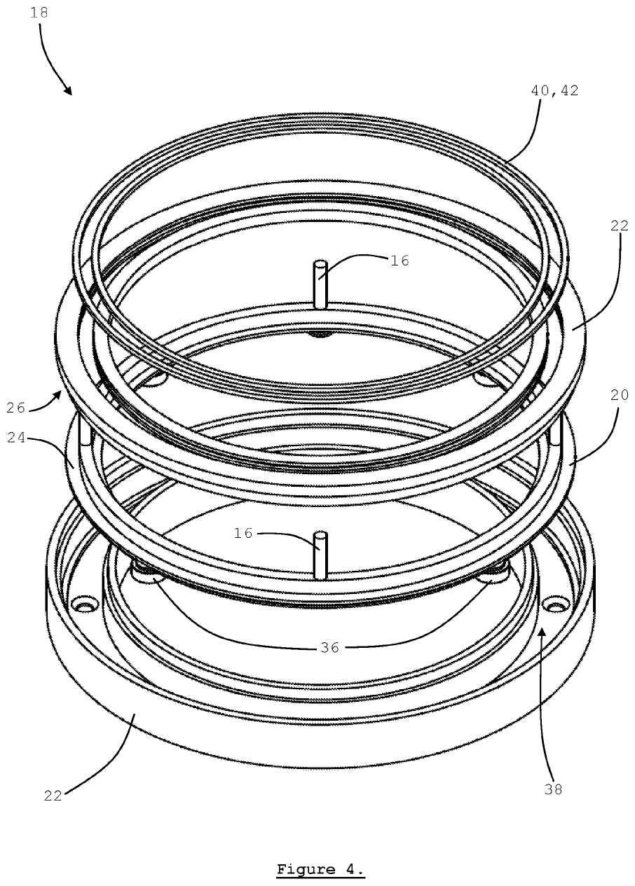

FIG. 5 is a diagrammatic bottom-view exploded representation of the pressure transfer arrangement FIG. 2;

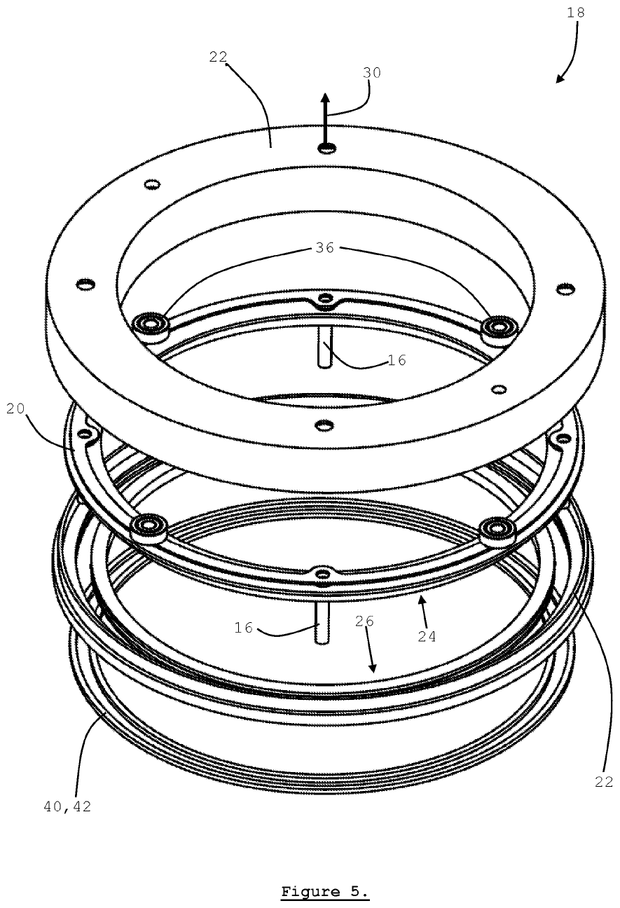

FIG. 6 is a diagrammatic front-view exploded perspective representation of the pressure transfer arrangement of FIG. 3; and

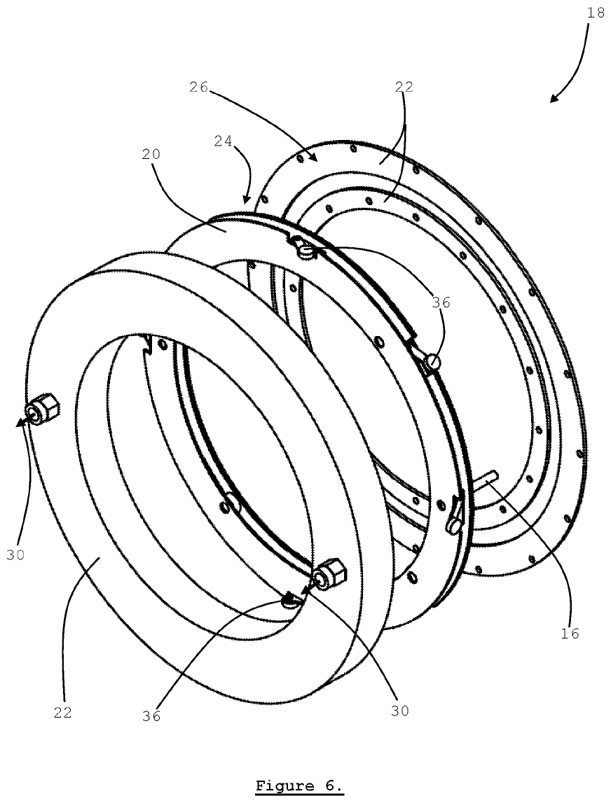

FIG. 7 is a diagrammatic rear-view exploded perspective representation of the pressure transfer arrangement of FIG. 3.

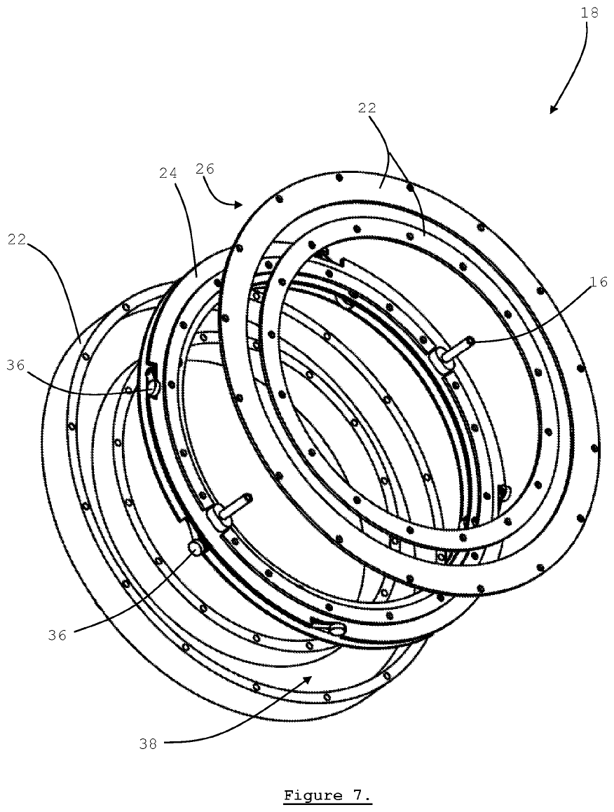

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

The present invention broadly provides for an ad hoc tyre pressure control assembly 10 for a tyred vehicle. Assembly 10 generally includes an air reservoir 12, an air compressor 14, and a pressure transfer arrangement 18. The assembly 10 finds particular application with off-road and 4×4 applications, such as vehicles driving on both sealed surfaces and sand, or the like, in order to control tyre pressure suited to an operating surface. For example, an off-road vehicle may travel to a beach via conventional tarred or asphalt roads, but then requires tyre pressure adjustment in order to improve traction on sand. The assembly 10 facilitates both automatic deflation and inflation, as described in more detail below. The skilled addressee is to appreciate that such a vehicle generally comprises an axle 6 which supports wheel 8, generally comprised of a tyre 8.2 arranged on a wheel rim 8.1.

In addition, it is to be appreciated that assembly 10 is described with reference to a single wheel 8, but is applicable to, for example, all four wheels of a vehicle, or a trailer towed by a vehicle, or the like. For example, assembly 10 may comprise a single air reservoir 12 and compressor 12, but with the reservoir 12 arranged in fluid communication with a plurality of wheels 8 by means of respective charging valves 16. In this manner, assembly 10 may be used to inflate or deflate a plurality of individual wheels, as required.

With reference now to the accompanying broad and diagrammatic figures, one embodiment of the assembly 10 comprises air reservoir 12 configured to store pressurised air, and air compressor 14 configured to operatively charge said reservoir 12 with pressurised air. In one embodiment, the air reservoir 12 and compressor 14 are unitary, such as a pump and tank combination, or the like. As generally known in the art, the air compressor 14 may be configured to be energised by means of a vehicle electrical system, such as a 12V system, a 24V system, or the like. In this manner, compressor 14 can be used to charge reservoir 12 with atmospheric air. The assembly 10 typically comprises an air pressure sensor (not shown) which is configured to sense and indicate pressure within the air reservoir 12 and/or the tyre 8.2.

Assembly 10 also includes a selectively controllable charging valve 16 which is arranged in fluid communication with the air reservoir 14, as shown. In one embodiment, the charging valve 16 comprises a solenoid valve or dump valve for transferring compressed air from the air reservoir 12 to a tyre 8.2 of a vehicle, but variations hereon are possible and expected. Typically, the selectively controllable charging valve 16 is controllable from a cabin of the vehicle. Each tyre may have its own charging valve 16, or a single charging valve 16 may supply more than one tyre, or the like. Of course, variations herein are possible and expected.

Importantly, assembly 10 includes a pressure transfer arrangement 18 via which pressurised air from the reservoir 12 is transferred to the tyre 8.1. Two possible embodiments of such a pressure transfer arrangement 18 are shown in the figures, but the skilled addressee is to appreciate that variations are possible and anticipated. In the exemplified embodiments, the pressure transfer arrangement 18 generally comprises a stator annulus 20 which is configured to be mounted about an axle 6 of a vehicle and arrangeable in fluid communication with a charging valve 16. The stator annulus 20 also defines a first peripheral sealing surface 24.

Pressure transfer arrangement 18 also includes a rotor annulus 22 which is configured to be mounted to a tyred wheel 8 of said vehicle and arranged in fluid communication with such a tyre 8.2 via a controllable check valve 30. Check valve 30 may be a solenoid check valve, a manually-releasable mechanical check valve, or the like. The rotor annulus 22 also defines a second peripheral sealing surface 26. Arrangement 18 further includes an urging component 36 which is configured to provide a predetermined urging force between the annuli 20 and 22 to separate the first and second peripheral sealing surfaces 24 and 26.

One annulus 20 or 22 generally defines an internal raceway 38 in which the other annulus 22 or 20, respectively, is complementarily captured to allow substantially unimpeded relative co-axial rotation between said annuli 20 and 22. In other words, one annulus defines the raceway 38 in which the other annulus is capturable to allow rotation within the other annulus. The skilled addressee is to appreciate that either the rotor or stator annulus is interchangeable depending on requirements, e.g. the stator captures the rotor, or vice versa. Such annuli may also be comprised of more than one part. For example, in the exemplified embodiment, the rotor annulus 22 captures the stator annulus 20, with the rotor annulus comprised of a lower part defining the internal raceway 38, as shown, and an upper portion or ring that fits onto the lower part once the stator annulus 20 is captured within the raceway 38.

The respective annuli 20 and 22 are complementarily configured to define an airtight air transfer passage 28 between the charging and check valves 16 and 30 when the predetermined urging force is overcome and the first and second peripheral sealing surfaces 24 and 26 are brought into abutment. In this manner, pressurised air is transferrable through said pressure transfer arrangement 18, wherein selective control of the charging and check valves 16 and 30 facilitates ad hoc tyre inflation or deflation of the tyre 8.2 without impeding rotation of the wheel on said axle 6.

In one embodiment, the annuli 20 and 22 are configured such that injection of pressurised air via the charging valve 16 overcomes the predetermined urging force to bring the first and second peripheral sealing surfaces 24 and 26 into abutment to form the airtight air transfer passage 28. In another embodiment, the pressure transfer arrangement 18 comprises an actuator (not shown) configured to overcome the predetermined urging force to bring the first and second peripheral sealing surfaces 24 and 26 into abutment to form the airtight air transfer passage 28.

Such an actuator may take a variety of forms, such

as a mechanical and/or electromechanical actuator. For example, a cable assembly may be used to overcome the predetermined urging force to bring the first and second peripheral sealing surfaces 24 and 26 into abutment. Alternatively, or additionally, an electromechanical driver, such as a solenoid and linear driver may be used to overcome the predetermined urging force to bring the first and second peripheral sealing surfaces 24 and 26 into abutment, or the like. Other examples may include pneumatic or hydraulic actuation, or the like. Variations hereon are possible and expected.

In one embodiment, the urging component 38 comprises a biased bearing configured to position one annulus within the raceway 38 of the other annulus, the bearing including a biasing element, such as a spring, providing the predetermined urging force. In another embodiment, the urging component 38 comprises a magnet configured to position one annulus within the raceway 38 of the other annulus, the magnet including a biasing element, such as a spring, providing the predetermined urging force. Again, variations hereon are possible and expected.

The skilled addressee is to appreciate that the predetermined urging force from the urging component 38 is typically not a relatively large force, but rather a force to separate the sealing surfaces 24 and 26 and allow one annulus to rotate relatively freely and unimpeded within the raceway 38 of the other annulus. This allows ‘normal’ and unimpeded rotation of the wheel 8 on the axle 6. When the predetermined force is overcome, either via injection of air and/or mechanical actuation, the predetermined force is overcome to displace the captured annulus in the raceway towards the other annulus, so that the sealing surfaces 24 and 26 are brought into abutment, thereby forming the substantially airtight air transfer passage 28 through the pressure transfer arrangement 18. Importantly, the sealing surfaces 24 and 26 may be configured to allow for ongoing relative rotation between the annuli 20 and 22 whilst the substantially airtight air transfer passage 28 is formed. The skilled addressee is to appreciate that ‘airtight’ is used in a non-limiting sense, meaning ‘sufficiently airtight to allow pressurised air to flow across the pressure transfer arrangement 18’, rather than ‘100% airtight’.

The first and second peripheral sealing surfaces 24 and 26 generally comprise opposite hard-facing surfaces on the annuli 20 and 22, such as tungsten carbide or silicon carbide, to facilitate sealing between the annuli whilst allowing unimpeded rotation. In an embodiment, the pressure transfer arrangement 18 further comprises a skirt or valvular seal 40 between the annuli 20 and 22 where air flow or pressure is directed onto itself to form a seal when the first and second peripheral sealing surfaces 24 and 26 are brought into abutment. Similarly, in one embodiment, the pressure transfer arrangement 18 may also comprise a contaminant protection seal 42 to prevent the ingress of unwanted contaminants into the air transfer passage 28, such as dirt, moisture, etc. Seals 40 and 42 may assist with establishing the air transfer passage 28, as well as prevent the ingress of unwanted contaminants.

In this manner, wheel 8 is generally able to turn freely on axle 6 without impediment from the pressure transfer arrangement 18, whilst tyre 8.2 is inflatable from air reservoir 12 when required. The controllable check valve 30 is typically configured to allow one-way pressurised air from the pressure transfer arrangement 18 into the tyre 8.2 to inflate said tyre 8.2. However, it is to be appreciated that the controllable check valve 30 may further be controllable to vent pressurised air from the tyre 8.2 to the atmosphere to deflate said tyre 8.2.

In this manner, the pressure transfer arrangement 18, along with selective control of the charging and check valves 16 and 30 facilitates ad hoc tyre inflation or deflation without impeding rotation of the wheel 8 on the axle 6. Importantly, assembly 10 is configured to allow pressurised air from the reservoir 12 to be charged or ‘dumped’ across the pressure transfer arrangement 18 over a short period of time, e.g. milliseconds.

Such a configuration means that air pressure can be quickly transferred across the pressure transfer arrangement 18 into tyre 8.2, where check valve 30 keeps such pressure within the tyre 8.2. As a result, assembly 10 does not require pressure to be held or maintained across the pressure transfer arrangement 18 to maintain a pressurised seal for long periods of time. In one embodiment, ‘dumping’ pressurised air into the pressure transfer arrangement 18 overcomes also the predetermined urging force to bring the first and second peripheral sealing surfaces 24 and 26 into abutment, i.e. the sudden increase in pressure pushes the annuli 20 and 22 sufficiently apart (overcomes the predetermined urging force from the urging component(s)) to form the substantially airtight air transfer passage 28.

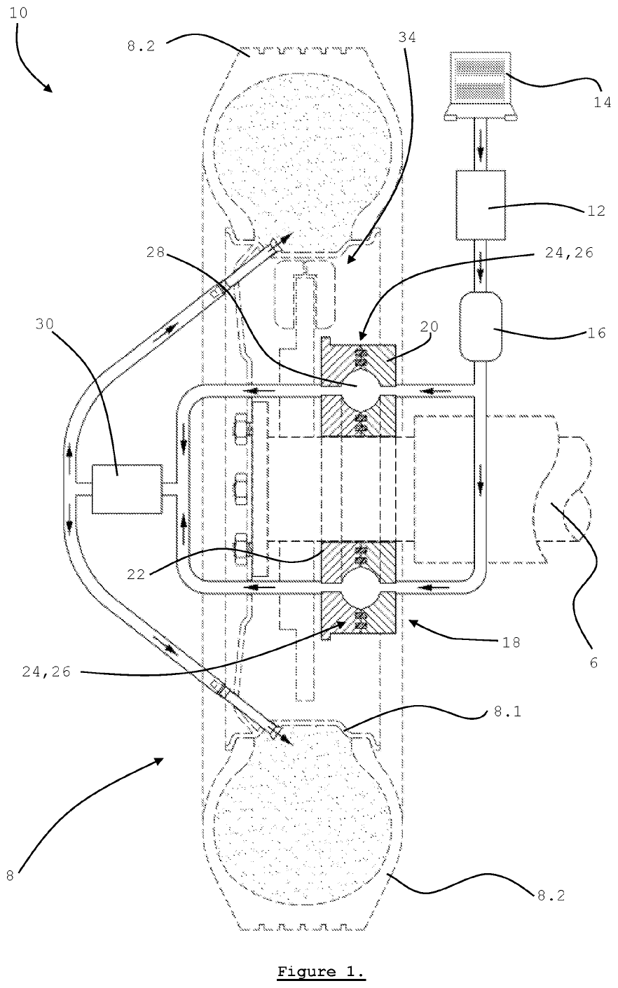

As diagrammatically indicated in FIG. 1, the annuli 20 and 22 may be incorporated into a brake arrangement 34 of the wheel 8, such as brake or drum brake arrangements. For example, the stator annulus 20 may comprise a brake caliper backing plate, and the rotor annulus 22 may comprise a disc brake rotor, or the like. The skilled addressee is to appreciate that variations hereon are possible, expected and within the scope of the present disclosure.

The skilled addressee is further to appreciate that the assembly 10 may be configured for remote operation, typically from a cabin of a vehicle. For example, air compressor 12, charging valve 16 and check valve 30 may be configured to be electronically-controlled from a vehicle cabin. To this end, it is to be appreciated that suitable electrical connections can be established across or between the annuli 20 and 22 of the pressure transfer arrangement 18, e.g. brush-like connections that allow unimpeded rotation whilst connecting to check valve 30, etc. In another embodiment, suitable electrical connections could also be brought into contact with an actuator such as a push-pull cable when the vehicle is stationary/moving slowly, or the like. Similarly, assembly 10 may additionally comprise an air pressure sensor 32 which is configured to sense and indicate pressure within the tyre 8.2, or the like. In this manner, by including suitable remote controls and indicators, operation of the assembly 10 can be monitored and controller as per requirements.

In use, assembly 10 allows tyre 8.2 to be inflated or deflated, as necessary and to suit vehicle requirements. For example, if a vehicle wishes to travel on sand, such as beach sand, check valve 30 can be controlled in order to deflate tyre 8.2 until a desired pressure within the tyre 8.2 is reached. The vehicle is then able to travel on sand. Once the vehicle reaches a sealed surface, such as a tarred road, compressor 14, air reservoir 12 and charging valve 16 can be operated or controlled in order to reach a specific air pressure in air reservoir 12, after which such pressure can be ‘dumped’ across the pressure transfer arrangement 18 into tyre 8.2. Importantly, as described, the specifically-configured annuli 20 and 22 of pressure transfer arrangement 18 facilitates such short air pressure transfer along with check valve 30, but does not require prolonged pressure being maintained across the pressure transfer arrangement 18 thereby facilitating ease-of-rotation between the annuli 20 and 22. Additionally, such inflation or deflation is achievable as the vehicle is moving, often from the cabin, without requiring the vehicle to come to a stop.

Applicant believes it particularly advantageous that the present invention provides for assembly 10 which can be configured to have no external air hoses that may get caught or damaged during off-road use. Assembly 20 can also be retrofitted to vehicles which do not include such an assembly 10 as original equipment. The pressure transfer arrangement 18 is configured to undergo less wear and tear as contact between the first and second sealing surfaces 24 and 26 is minimised to allow relative rotation between the annuli 20 and 22 when air pressure is not transferred via the ‘formed-on-demand’ airtight air transfer passage 28.

Assembly 10 can be retrofitted to an existing vehicle, and does not have components that are vulnerable to damage in challenging environments. Assembly 10 can also operate around existing brake systems or be incorporated into existing components such as a brake rotor and backing plate on a disk brake or a drum and backing plate on a drum brake. Additionally, inflation or deflation of a tyre can occur while the vehicle is moving, or at least without requiring a driver to exit the vehicle and attend to such inflation or deflation directly at the wheel.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A pressure transfer arrangement for an ad hoc tyre pressure control assembly, said pressure transfer arrangement comprising:
a stator annulus configured to be mounted about an axle of a vehicle and arrangeable in fluid communication with a charging valve, the stator annulus defining a first peripheral sealing surface;
a rotor annulus configured to be mounted to a tyred wheel of said vehicle and arranged in fluid communication with such a tyre via a controllable check valve, the rotor annulus defining a second peripheral sealing surface; and
an urging component configured to provide a predetermined urging force between the annuli to separate the first and second peripheral sealing surfaces;
wherein one annulus defines an internal raceway in which the other annulus is complementarily captured to allow substantially unimpeded relative co-axial rotation between said annuli; and
wherein the annuli are complementarily configured to define an airtight air transfer passage between the charging and check valves when the predetermined urging force is overcome via suitable actuation and the first and second peripheral sealing surfaces are brought into abutment, so that pressurised air is transferrable through said pressure transfer arrangement;
wherein selective control of the charging and check valves facilitates ad hoc tyre inflation or deflation of the tyre without impeding rotation of the wheel on said axle.

2. The pressure transfer arrangement of claim 1, wherein the annuli are configured such that injection of pressurised air via the charging valve acts as said suitable actuation in order to overcome the predetermined urging force to bring the first and second peripheral sealing surfaces into abutment to form the airtight air transfer passage.

3. The pressure transfer arrangement of claim 1, which comprises an actuator configured to provide said suitable actuation to overcome the predetermined urging force to bring the first and second peripheral sealing surfaces into abutment to form the airtight air transfer passage.

4. The pressure transfer arrangement of claim 3, wherein the actuator comprises a mechanical and/or electromechanical actuator.

5. The pressure transfer arrangement of claim 1, wherein the first and second peripheral sealing surfaces comprise opposite hard-facing surfaces, such as tungsten carbide or silicon carbide, to facilitate sealing between the annuli whilst allowing unimpeded rotation.

6. The pressure transfer arrangement of claim 1, wherein the urging component comprises a biased bearing configured to position one annulus within the raceway of the other annulus, the bearing including a biasing element, such as a spring, providing the predetermined urging force.

7. The pressure transfer arrangement of claim 1, wherein the urging component comprises a magnet configured to position one annulus within the raceway of the other annulus, the magnet including a biasing element, such as a spring, providing the predetermined urging force.

8. The pressure transfer arrangement of claim 1, which comprises a skirt or valvular seal between the annuli where air flow or pressure is directed onto itself to form a seal when the first and second peripheral sealing surfaces are brought into abutment.

9. The pressure transfer arrangement of claim 1, which comprises a contaminant protection seal to prevent the ingress of unwanted contaminants into the air transfer passage.

10. The pressure transfer arrangement of claim 1, wherein the annuli are incorporated into a brake arrangement of the wheel.

11. The pressure transfer arrangement of claim 10, wherein the stator annulus comprises a brake caliper backing plate.

12. The pressure transfer arrangement of claim 10, wherein the rotor annulus comprises a disc brake rotor.

13. An ad hoc tyre pressure control assembly for a tyred vehicle, said assembly comprising:
an air reservoir configured to store pressurised air;
an air compressor configured to operatively charge said reservoir with pressurised air;
a selectively controllable charging valve arranged in fluid communication with said air reservoir; and
a pressure transfer arrangement comprising:
i) a stator annulus configured to be mounted about an axle of said vehicle and arranged in fluid communication with the charging valve, the stator annulus defining a first peripheral sealing surface;
ii) a rotor annulus configured to be mounted to a tyred wheel of said vehicle and arranged in fluid communication with such a tyre via a controllable check valve, the rotor annulus defining a second peripheral sealing surface; and
iii) an urging component configured to provide a predetermined urging force between the annuli to separate the first and second peripheral sealing surfaces;
wherein one annulus defines an internal raceway in which the other annulus is complementarily captured to allow substantially unimpeded relative co-axial rotation between said annuli; and
wherein the annuli are complementarily configured to define an airtight air transfer passage between the charging and check valves when the predetermined urging force is overcome via suitable actuation and the first and second peripheral sealing surfaces are brought into abutment so that pressurised air is transferrable through said pressure transfer arrangement;
so that selective control of the charging and check valves facilitates ad hoc tyre inflation or deflation without impeding rotation of the wheel on said axle.

14. The ad hoc tyre pressure control assembly of claim 13, wherein the air reservoir and compressor are unitary, such as a pump and tank combination.

15. The ad hoc tyre pressure control assembly of claim 13, wherein the air compressor is configured to be energised by means of a vehicle electrical system, such as a 12V system.

16. The ad hoc tyre pressure control assembly of claim 13, which comprises an air pressure sensor configured to sense and/or indicate pressure within the air reservoir and/or tyre.

17. The ad hoc tyre pressure control assembly of claim 13, wherein the charging valve comprises a solenoid valve for transferring compressed air from the air reservoir, via the pressure transfer arrangement, to the tyre.

18. The ad hoc tyre pressure control assembly of claim 13, wherein the selectively controllable charging valve is controllable from a cabin of the vehicle.

19. The ad hoc tyre pressure control assembly of claim 13, wherein the controllable check valve is configured to allow one-way pressurised air from the pressure transfer arrangement into the tyre to inflate said tyre.

20. The ad hoc tyre pressure control assembly of claim 13, wherein the controllable check valve is controllable from a cabin of the vehicle to vent pressurised air to the atmosphere to deflate said tyre.

21-25. (canceled)
